(19) United States
(12) Patent Application Publication
(10) Pub. No.: US 2026/0353085 A1
(43) Pub. Date: Nov. 5, 2026

(54) UE POSITION VALIDATION USING RAW MODE FOR UE TRANSMISSIONS

(71) Applicant: Nokia Technologies Oy, Espoo (FI)

(72) Inventors: Frank FREDERIKSEN, Klarup (DK); Rafhael MEDEIROS DE AMORIM, Aalborg (DK); Jeroen WIGARD, Klarup (DK); Konstantinos MANOLAKIS, Munich (DE)

(73) Assignee: Nokia Technologies Oy, Espoo (FI)

(21) Appl. No.: 19/118,536

(22) PCT Filed: Oct. 3, 2023
(86) PCT No.: PCT/EP2023/077314

§ 371 Date: Apr. 4, 2025

(30) Foreign Application Priority Data
Oct. 7, 2022 (GB) 2214730.0

(51) Int. Cl. H04W 12/104; H04W 12/61; H04W 12/63; H04W 56/00; H04W 84/06

(52) U.S. Cl. CPC H04W 12/104; H04W 12/61; H04W 12/63; H04W 56/0045; H04W 84/06

(57) ABSTRACT

An apparatus comprising: at least one processor; and at least one memory storing instructions that, when executed by the at least one processor, cause the apparatus at least to: receive, from a network, a configuration to transition to a secondary mode of transmission; wherein the transition to the secondary mode comprises modifying at least one network time compensation setting or at least one network frequency compensation setting; and transmit, to the network, a signal in the secondary mode of transmission.

### TECHNICAL FIELD

The examples and non-limiting example embodiments relate generally to communications and, more particularly, to UE position validation using a raw mode for UE transmissions.

### BACKGROUND

It is known to determine a position of a user equipment within a communication network.

### SUMMARY

In accordance with an aspect, an apparatus includes at least one processor; and at least one memory storing instructions that, when executed by the at least one processor, cause the apparatus at least to: receive, from a network, a configuration to transition to a secondary mode of transmission; wherein the transition to the secondary mode comprises modifying at least one network time compensation setting or at least one network frequency compensation setting; and transmit, to the network, a signal in the secondary mode of transmission.

In accordance with an aspect, an apparatus includes at least one processor; and at least one memory storing instructions that, when executed by the at least one processor, cause the apparatus at least to: transmit, to a terminal device, a configuration used with the terminal device to transition to a secondary mode of transmission; wherein the transition to the secondary mode comprises modification of at least one network time compensation setting or at least one network frequency compensation setting; and receive a signal from the terminal device in the secondary mode of transmission.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example non-terrestrial network.

FIG. 3 shows a signaling diagram illustrating the examples described herein.

FIG. 4 is an example apparatus configured to implement the examples described herein.

FIG. 5 shows a representation of an example of non-volatile memory media.

FIG. 6 is an example method implementing the examples described herein.

FIG. 7 is an example method implementing the examples described herein.

### DETAILED DESCRIPTION OF EXAMPLE EMBODIMENTS

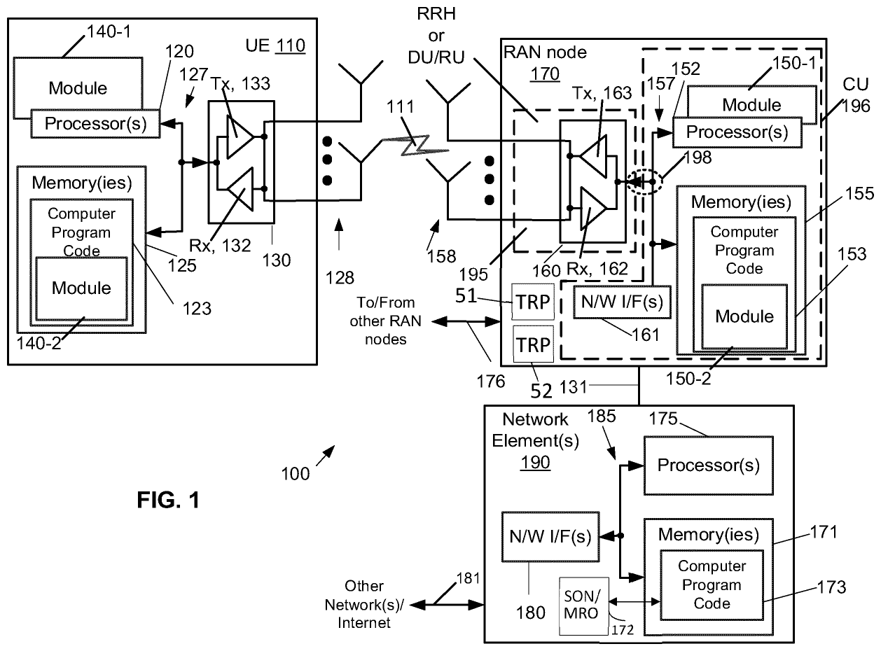

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, it is the functionality which carries UE functionalities. The distributed unit part of the IAB node facilitates the so called access link (child link) connections (i.e. for access link UEs, and backhaul for other IAB nodes, in the case of multi-hop IAB). In other words, it is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including UE position validation using a raw mode (e.g. an alternative mode or a secondary mode or an uncompensated mode) for UE transmissions. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

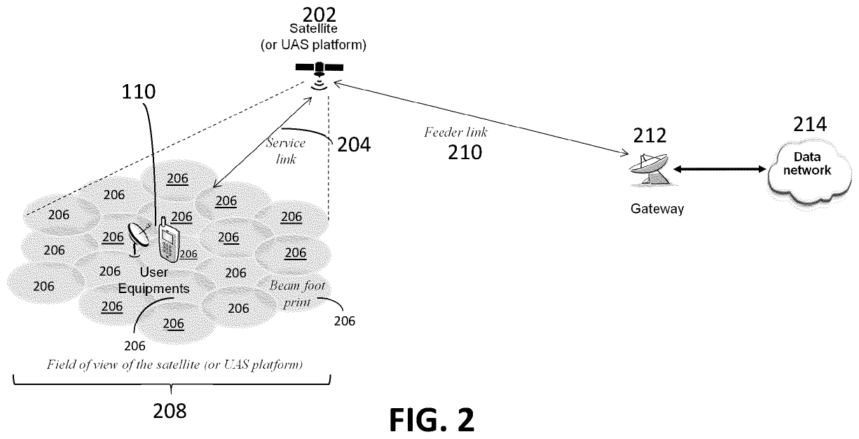

The feasibility of using 5G NR standards to support non-terrestrial networks has been studied during 3GPP releases 15 and 16. In December 2019, the 3GPP RAN plenary meeting approved the normative specification work item for NTN in release 17. In the work item, the UEs supporting NTN are assumed to have GNSS capability, with reference to solutions for NR to support non-terrestrial networks (NTN). In an NTN system, 5G base stations (gNB) are deployed on board satellites to provide communication coverage over a very large area that may be otherwise unreachable by cellular networks. The NTN system can be used to connect IoT devices globally as well as provide personal communication in remote areas and in disaster relief. FIG. 2 shows an example NTN scenario.

FIG. 2 shows a satellite or UAS platform 202 providing communication access to a user equipment 110 via a service link 204. The field of view 208 of the satellite or UAS platform 202 is given by a plurality of beams that make up a beam footprint. Each beam is shown as item 206. One or more of the beams 206 are used by the user equipment 110 to transmit data to and receive data from the satellite or UAS platform 202 over the service link 204, and/or one or more of the beams 206 are used by the satellite or UAS platform 202 to transmit data to and receive data from the user equipment 110 over the service link 204. The satellite or UAS platform 202 transmits data to and receives data from gateway 212 over the feeder link 210, and the gateway 212 transmits data to and receives data from the data network 214, which data network 214 is accessible to the user equipment 110 with the configuration shown in FIG. 2.

There are different types of satellite orbits that have been studied for NR access included low earth orbit (LEO) satellites which orbit at approximately 600 km above the earth. LEO is assumed to be among the more interesting engineering cases, compared with higher orbits like geostationary satellites. During the Rel-16 study item the typical beam footprint size for a LEO satellite was assumed to be between a 100-1000 km radius. So one LEO satellite can cover a very large area on the earth which may include multiple countries.

The angle of arrival (AoA) of radio signals can be measured at a receiver and recently improved accuracy algorithms have become more available such as super-resolution algorithms like MUSIC and others involving MIMO arrays, as low complexity direction of arrival (DoA) estimation may be performed for 2D massive MIMO systems. AoA works best in LoS scenarios which are typical for NTN access.

Further, in June 2022 RAN #96 has opened and closed a study on requirements and use cases for network verified UE location for non-terrestrial networks (NTN). The study had the following recommendation (with quoted (‘ ’) highlights):
In this study, we have identified the need to define a network based solution which aims at verifying the reported UE location information.
‘The verification should be performed independently from the location information reported by UE.’
The UE location information for the study is considered verified if the reported UE location is consistent with the network based assessment to within 5-10 km (similar to terrestrial network macro cell size), enabling country discrimination and selection of an appropriate core network in order to support all the regulatory services (i.e. emergency call, lawful intercept, public warning, charging/billing).
‘The solution should not impact significantly the latency of the targeted services’ nor infringe privacy requirements that apply to the UE location.
The study in [RAN2, RAN1, RAN3], which will study and evaluate solutions for the network to verify UE reported location information, ‘shall consider the following aspects’:
‘The scenario of single satellite’ (or HAPS) ‘in view by the UE at a time is considered with higher priority.”
Multiple satellite (or HAPS) in view by the UE may be considered if time allows
Assume that the UE is attached to a network (so that its context has been set up in the network) for the purpose of positioning
Different solutions or positioning methods for NGSO, GSO or HAPS are not precluded
When considering solutions based on positioning methods, existing 3GPP defined RAT dependent positioning methods shall be considered as baseline. Other methods are not precluded.
Solutions using existing NG-RAN architecture and procedures shall be considered

The updated work item description, namely RP-221819, “Revised WID: NR NTN (Non-Terrestrial Networks) enhancements”, points to further investigations and studies in this domain.

One of the main problems with the current assumptions for the network verified UE location is that the main focus is on the single satellite operation, meaning that the network entities are only able to gather information from a single satellite (potentially multiple samples from the same satellite over time), and that the latency requirements do not really allow for spanning a very long time for collecting the needed samples. Of course the validation process may be running in the background allowing collection of long-term information, but that would not show up with short-term results for allowing or disallowing a UE's access to the network.

For NR over NTN, the current assumption is that the UE is able to understand its own geographical location, such as its GNSS location, as well as the satellite's location in space, with directional information such that is it possible to extrapolate along the satellite's trajectory. Under normal conditions the UE would use this information to compensate in an autonomous manner for the channel impacts that happen due to the satellite movement over the sky. Such impacts include Doppler offsets (due to the satellites speed of 7.5 km/s), and long propagation delays (due to the satellite's altitude of 300-1200 km for low earth orbits (LEO)). Such UE autonomous compensation of channel impacts are needed in order for the UL transmissions from different UEs to be aligned at the satellite receive antenna prior to being fed to the gNB on the ground, as it is assumed that the satellites are operating in a transparent manner. That is, the satellite is simply acting as an analog forwarding node, which makes sure that the signals for both UL and DL are being fed to the right direction either to the gNB 170 or to the UE 110.

The NTN enhancements work item has been updated to also include this concept of network verified UE position, which means that it is desirable for the network to be able to have mechanisms to validate whether the UE reported location is to be trusted or not. In some cases it may be assumed that a UE would report its true location, but there may be multiple reasons that a UE may want to report a “false location”, which includes, but may not be limited to:
A) Avoiding tracking from the network, such as to avoid tracking from authorities/companies.
B) Wanting to be seen as located in another country than a current country, e.g. for billing purposes.
C) Wanting to be seen as located in another country than a current country, e.g. for being able to access country restricted content—which could work both ways—as some content is only available in some countries, and some information is not accessible in some countries.

Under such conditions, the UE may want to “spoof” its position, meaning that it is reporting one thing to the operating network, while it is located in another position to gain the abovementioned benefits.

In other cases, it may be that GNSS is not available, e.g. due to indoor UE location, because the UE does not receive signals from a sufficient number of GNSS satellites, or due to other reasons as interference, spoofing etc. which GNSS systems are sensitive to. In such case, the UE would also report a false/inaccurate location to the network.

The examples described herein relate to the network (170, 190, 202, 212) being able to put the UE 110 into a “raw transmission mode”, meaning that in this mode, the UE 110 would be disabling one or more of its autonomous compensation mechanisms such that the gNB (170, 202) would be observing the physical impacts to the radio channel signal that the UE would otherwise normally be compensating. In one embodiment of the invention, the UE would be doing “partial compensation”, but still be transmitting a “raw signal”, but now just compensated in a predefined way in time and/or frequency, e.g. to a “fix-point” that has been provided by the network. In another embodiment the network specifies in which domain (time or frequency) the raw mode should be executed.

The signal that the UE would be transmitting in this “raw transmission mode” may be characterized by being a known signal from the base station (gNB), and the signal would have known characteristics, such as for instance preamble sequence, PUCCH transmission, or PUSCH transmission, and the transmission may happen on pre-defined physical resources in time, frequency, code and power domains. The transmission may be also limited to one or some physical channels.

By observing the “raw transmission mode” signal as received by the gNB, the gNB determines the physical characteristics of this received signal and verifies whether these match (at least within certain margins) with the expected signal characteristics based on the reported UE location.

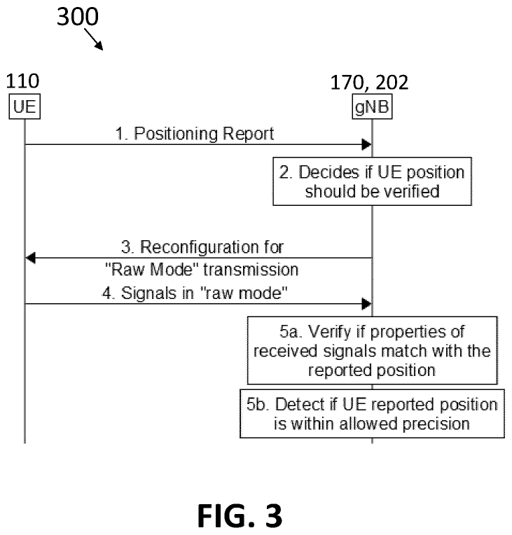

The method is detailed in the flow chart 300 of FIG. 3 and through the following description.
1. The UE 110 reports its position to the network as included in the 3GPP specifications for NTN.
2. The network (170, 190, 202, 212) wants to verify the UE position. A reason can be e.g. that the cell the user is connected to is covering multiple countries and the network wants to ensure the user is connected to the correct PLMN. Another reason could be that the network detects from the UE's UL signal that the UE may be not sufficiently synchronized, which means the UE may have inaccurate GNSS location information.
3. The network takes action and instructs the UE to move into ‘raw mode’, meaning the UE turns some of the NTN specific time and frequency precompensation mechanisms off or changes the settings according to predefined settings. This means that the UE is not precompensating any more for time delay and/or Doppler shift on the service link 204 and/or at least part of the feeder link 210 as it does when synchronized and having accurate location information. When pre-compensating towards a known fix-point, the UE would be performing partial compensation, but UE's distance to the fix-point would be reflected in the received signals at the gNB. The signaling for configuration and activation/deactivation can be done through RRC signaling, a MAC command or a broadcast as part of a list of UEs to be moved into this mode. Different options can be applied:
3a. Full raw mode: the UE starts behaving like being connected to a TN, i.e. it turns all precompensation in time and frequency off.
3b. Time raw mode: the UE precompensates for the frequency but does not precompensate for the time shifts, but only applies network timing commands.
3c. Frequency raw mode: the UE precompensates for the time shifts, but does not precompensate for the frequency shifts.
3d. Different reference point: the reference point for time and/or frequency is changed towards which the precompensation is done.
3e. Specific precompensation values: instead of providing a reference point, explicit values to be used for time and/or frequency precompensation are provided to the UE.
4. The UE sends signals in the raw mode. The signals may be the normal communication or the transmission may be a signal known by the network, either UE specific or a general raw signal. The kind of signal may be communicated to the UE through RRC, broadcasted or preconfigured.
5. The network detects the signal, which will be shifted in time/or frequency according to the mode chosen. As the network knows the reported position (step 1) the network can verify if the received time and frequency can belong to a UE on the reported position, or within a certain radius around the reported UE position. This step may be sub-divided into two functions. The first (5a) would verify whether one or more properties of the received signal match the expected values, for instance if the timing of the received signal matches the expectation based on UE reported location, and the second function (5b) would determine/detect if the validation procedure is able to verify the UE position within certain limits, for instance a 5 km or 10 km radius of the reported location.

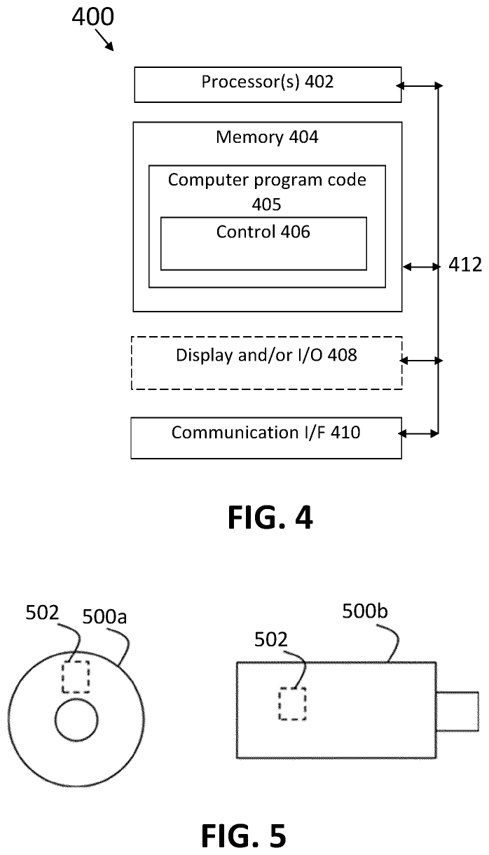

FIG. 4 is an example apparatus 400, which may be implemented in hardware, configured to implement the examples described herein. The apparatus 400 comprises at least one processor 402 (e.g. an FPGA and/or CPU), at least one memory 404 including computer program code 405, wherein the at least one memory 404 and the computer program code 405 are configured to, with the at least one processor 402, cause the apparatus 400 to implement circuitry, a process, component, module, or function (collectively control 406) to implement the examples described herein, including UE position validation using a raw mode for UE transmissions. The memory 404 may be a non-transitory memory, a transitory memory, a volatile memory (e.g. RAM), or a non-volatile memory (e.g. ROM).

The apparatus 400 optionally includes a display and/or I/O interface 408 that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 400 includes one or more communication e.g. network (N/W) interfaces (I/F(s)) 410. The communication I/F(s) 410 may be wired and/or wireless and communicate over the Internet/other network(s) via any communication technique. The communication I/F(s) 410 may comprise one or more transmitters and one or more receivers. The communication I/F(s) 410 may comprise standard well-known components such as an amplifier, filter, frequency-converter, (de) modulator, and encoder/decoder circuitries and one or more antennas.

The apparatus 400 to implement the functionality of control 406 may be UE 110, RAN node 170 (e.g. gNB), or network element(s) 190. Thus, processor 402 may correspond to processor(s) 120, processor(s) 152 and/or processor(s) 175, memory 404 may correspond to memory(ies) 125, memory(ies) 155 and/or memory(ies) 171, computer program code 405 may correspond to computer program code 123, module 140-1, module 140-2, and/or computer program code 153, module 150-1, module 150-2, and/or computer program code 173, and communication I/F(s) 410 may correspond to transceiver 130, antenna(s) 128, transceiver 160, antenna(s) 158, N/W I/F(s) 161, and/or N/W I/F(s) 180. Alternatively, apparatus 400 may not correspond to either of UE 110, RAN node 170, or network element(s) 190, as apparatus 400 may be part of a self-organizing/optimizing network (SON) node, such as in a cloud.

The apparatus 400 may also be distributed throughout the network (e.g. 100) including within and between apparatus 400 and any network element (such as a network control element (NCE) 190 and/or the RAN node 170 and/or the UE 110).

Interface 412 enables data communication between the various items of apparatus 400, as shown in FIG. 4. For example, the interface 412 may be one or more buses such as address, data, or control buses, and may include any interconnection mechanism, such as a series of lines on a motherboard or integrated circuit, fiber optics or other optical communication equipment, and the like. Computer program code 405, including control 406 may comprise object-oriented software configured to pass data or messages between objects within computer program code 405. The apparatus 400 need not comprise each of the features mentioned, or may comprise other features as well.

FIG. 5 shows a schematic representation of non-volatile memory media 500a (e.g. computer disc (CD) or digital versatile disc (DVD)) and 500b (e.g. universal serial bus (USB) memory stick) storing instructions and/or parameters 502 which when executed by a processor allows the processor to perform one or more of the steps of the methods described herein.

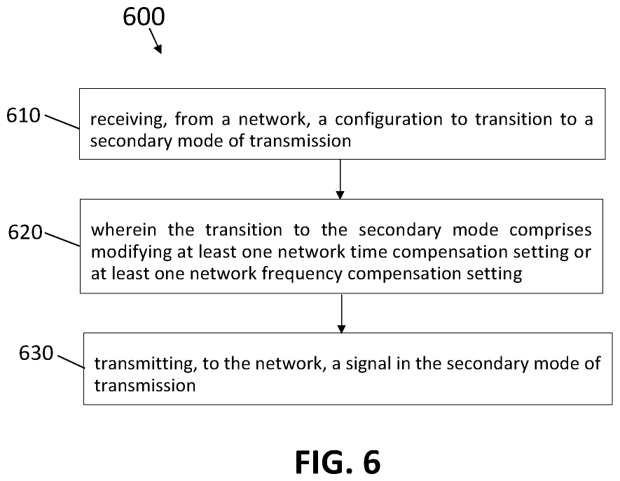

FIG. 6 is an example method 600 to implement the example embodiments described herein. At 610, the method includes receiving, from a network, a configuration to transition to a secondary mode of transmission. At 620, the method includes wherein the transition to the secondary mode comprises modifying at least one network time compensation setting or at least one network frequency compensation setting. At 630, the method includes transmitting, to the network, a signal in the secondary mode of transmission. Method 600 may be performed with UE 110 or apparatus 400.

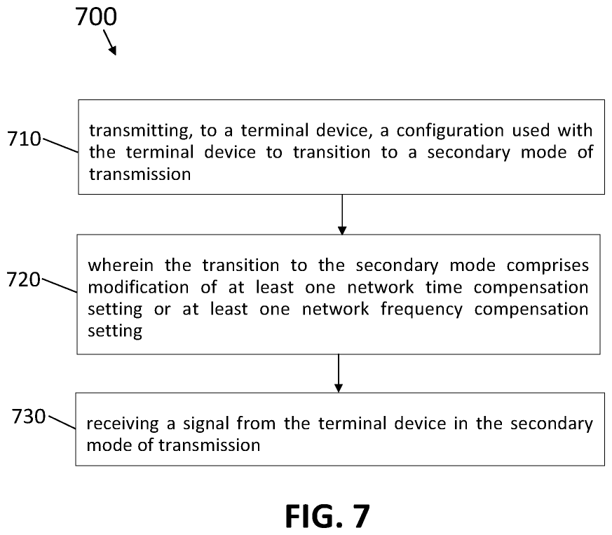

FIG. 7 is an example method 700 to implement the example embodiments described herein. At 710, the method includes transmitting, to a terminal device, a configuration used with the terminal device to transition to a secondary mode of transmission. At 720, the method includes wherein the transition to the secondary mode comprises modification of at least one network time compensation setting or at least one network frequency compensation setting. At 730, the method includes receiving a signal from the terminal device in the secondary mode of transmission. Method 700 may be performed with network node 170, satellite 202, or apparatus 400.

The following examples are provided and described herein.
Example 1. An apparatus including: at least one processor; and at least one memory storing instructions that, when executed by the at least one processor, cause the apparatus at least to: receive, from a network, a configuration to transition to a secondary mode of transmission; wherein the transition to the secondary mode comprises modifying at least one network time compensation setting or at least one network frequency compensation setting; and transmit, to the network, a signal in the secondary mode of transmission.
Example 2. The apparatus of example 1, wherein the transmitted signal is configured to be used with the network to verify a position of a terminal device.
Example 3. The apparatus of any of examples 1 to 2, wherein the apparatus is caused to: report to the network a timing advance used with a terminal device, the timing advance configured to be used with the network to verify a position of the terminal device with comparison of the timing advance to at least one characteristic of a channel used for transmission of the signal in a primary mode.
Example 4. The apparatus of any of examples 1 to 3, wherein the apparatus is caused to: report a position of a terminal device to the network for verification of the position of the terminal device.
Example 5. The apparatus of any of examples 1 to 4, wherein the at least one network time compensation setting comprises a setting for a non-terrestrial network, and the at least one network frequency compensation setting comprises a setting for a non-terrestrial network.
Example 6. The apparatus of any of examples 1 to 5, wherein the apparatus is caused to perform at least one of: disable a terminal device specific time delay compensation or a common time delay compensation; or disable Doppler shift compensation on a service link to a network or a feeder link to a gateway.
Example 7. The apparatus of any of examples 1 to 6, wherein the secondary mode comprises the network having knowledge of at least one known characteristic of the signal.
Example 8. The apparatus of example 7, wherein the at least one known characteristic of the signal comprises transmission of the signal with at least one of: a preamble sequence; a physical channel; a physical uplink control channel; a physical uplink shared channel; a pre-defined physical resource in a time domain; a pre-defined physical resource in a frequency domain; a pre-defined physical resource in a code domain; or a pre-defined physical resource in a power domain.
Example 9. The apparatus of any of examples 1 to 8, wherein the apparatus is caused to perform at least one of: disable both time compensation and frequency compensation to simulate connection to a terrestrial network; disable time compensation and apply at least one network timing command while compensating for frequency shift; or disable frequency compensation while compensating for time shift.
Example 10. The apparatus of any of examples 1 to 9, wherein the apparatus is caused to: receive, from the network, a fixed point known to the network; and adjust time delay compensation or Doppler frequency compensation based on the fixed point known to the network.
Example 11. The apparatus of any of examples 1 to 10, wherein the apparatus is caused to: receive, from the network, at least one value to use for the modifying of the at least one network time compensation setting or the at least one network frequency compensation setting; and compensate using the at least one value received from the network.
Example 12. The apparatus of any of examples 1 to 11, wherein the at least one network time compensation setting and the at least one network frequency compensation setting configure the terminal device to compensate for at least one channel impact occurring due to satellite movement.
Example 13. An apparatus including: at least one processor; and at least one memory storing instructions that, when executed by the at least one processor, cause the apparatus at least to: transmit, to a terminal device, a configuration used with the terminal device to transition to a secondary mode of transmission; wherein the transition to the secondary mode comprises modification of at least one network time compensation setting or at least one network frequency compensation setting; and receive a signal from the terminal device in the secondary mode of transmission.
Example 14. The apparatus of example 13, wherein the apparatus is caused to: verify a position of the terminal device, based on the signal received in the secondary mode of transmission.
Example 15. The apparatus of any of examples 13 to 14, wherein the apparatus is caused to: receive a timing advance used with the terminal device; and verify a position of the terminal device with comparing the timing advance to at least one characteristic of the channel used for transmission of the signal in a primary mode.
Example 16. The apparatus of any of examples 13 to 15, wherein the apparatus is caused to: receive, with a network from a terminal device, a reported position of the terminal device; and verify the reported position of the terminal device, based on the signal received in the secondary mode of transmission; wherein verifying the reported position of the terminal device comprises comparing at least one physical characteristic of the received signal to at least one expected characteristic of the received signal.
Example 17. The apparatus of any of examples 13 to 16, wherein the at least one network time compensation setting comprises a setting for a non-terrestrial network, and the at least one network frequency compensation setting comprises a setting for a non-terrestrial network.
Example 18. The apparatus of any of examples 13 to 17, wherein the apparatus is caused to perform at least one of: configure the terminal device to disable a terminal device specific time delay compensation or a common time delay compensation; or configure the terminal device to disable Doppler shift compensation on a service link to the network or a feeder link to a gateway.
Example 19. The apparatus of any of examples 13 to 18, wherein the secondary mode comprises the network having knowledge of at least one known characteristic of the signal.
Example 20. The apparatus of example 19, wherein the at least one known characteristic of the signal comprises transmission of the signal with at least one of: a preamble sequence; a physical channel; a physical uplink control channel; a physical uplink shared channel; a pre-defined physical resource in a time domain; a pre-defined physical resource in a frequency domain; a pre-defined physical resource in a code domain; or a pre-defined physical resource in a power domain.
Example 21. The apparatus of any of examples 13 to 20, wherein the apparatus is caused to perform at least one of: configure the terminal device to disable both time compensation and frequency compensation to simulate connection to a terrestrial network; configure the terminal device to disable time compensation and apply at least one network timing command and compensate for frequency shift; or configure the terminal device to disable frequency compensation and compensate for time shift.
Example 22. The apparatus of any of examples 13 to 21, wherein the apparatus is caused to: transmit, to the terminal device, a fixed point known to the network; and configure the terminal device to adjust time delay compensation or Doppler frequency compensation based on the fixed point known to the network.
Example 23. The apparatus of any of examples 13 to 22, wherein the apparatus is caused to: transmit, to the terminal device, at least one value to use for the modification of the at least one non-terrestrial network time compensation setting or the at least one non-terrestrial network frequency compensation setting; and configure the terminal device to compensate with use of the at least one value transmitted to the terminal device.
Example 24. The apparatus of any of examples 13 to 23, wherein the at least one non-terrestrial network time compensation setting and the at least one non-terrestrial network frequency compensation setting configure the terminal device to compensate for at least one channel impact occurring due to satellite movement.
Example 25. The apparatus of any of examples 13 to 24, wherein the apparatus is caused to: determine a possible position of the terminal device given the signal received in the secondary mode, based on a timing of the signal or a frequency of the signal; and determine a difference between the possible position of the terminal device given the signal received in the secondary mode, and the reported position of the terminal device; and verify the reported position of the terminal device with determining whether the difference is within a value, wherein the value comprises a radius or other value.
Example 26. A method including: receiving, from a network, a configuration to transition to a secondary mode of transmission; wherein the transition to the secondary mode comprises modifying at least one network time compensation setting or at least one network frequency compensation setting; and transmitting, to the network, a signal in the secondary mode of transmission.
Example 27. A method including: transmitting, to a terminal device, a configuration used with the terminal device to transition to a secondary mode of transmission; wherein the transition to the secondary mode comprises modification of at least one network time compensation setting or at least one network frequency compensation setting; and receiving a signal from the terminal device in the secondary mode of transmission.
Example 28. An apparatus including: means for receiving, from a network, a configuration to transition to a secondary mode of transmission; wherein the transition to the secondary mode comprises modifying at least one network time compensation setting or at least one network frequency compensation setting; and means for transmitting, to the network, a signal in the secondary mode of transmission.
Example 29. An apparatus including: means for transmitting, to a terminal device, a configuration used with the terminal device to transition to a secondary mode of transmission; wherein the transition to the secondary mode comprises modification of at least one network time compensation setting or at least one network frequency compensation setting; and means for receiving a signal from the terminal device in the secondary mode of transmission.
Example 30. A non-transitory program storage device readable by a machine, tangibly embodying a program of instructions executable with the machine for performing operations, the operations including: receiving, from a network, a configuration to transition to a secondary mode of transmission; wherein the transition to the secondary mode comprises modifying at least one network time compensation setting or at least one network frequency compensation setting; and transmitting, to the network, a signal in the secondary mode of transmission.
Example 31. A non-transitory program storage device readable by a machine, tangibly embodying a program of instructions executable with the machine for performing operations, the operations including: transmitting, to a terminal device, a configuration used with the terminal device to transition to a secondary mode of transmission; wherein the transition to the secondary mode comprises modification of at least one network time compensation setting or at least one network frequency compensation setting; and receiving a signal from the terminal device in the secondary mode of transmission.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash, hyphen, or number):

| | |
|---|---|
| 2D | two-dimensional |
| 3GPP | third generation partnership project |
| 4G | fourth generation |
| 5G | fifth generation |
| 5GC | 5G core network |
| AMF | access and mobility management function |
| AoA | angle of arrival |
| ASIC | application-specific integrated circuit |
| CPU | central processing unit |
| CU | central unit or centralized unit |
| DL | downlink |
| DoA | direction of arrival |
| DSP | digital signal processor |
| eNB | evolved Node B (e.g., an LTE base station) |
| EN-DC | E-UTRAN new radio - dual connectivity |
| en-gNB | node providing NR user plane and control plane protocol |
| | terminations towards the UE, and acting as |
| | a secondary node in EN-DC |
| E-UTRA | evolved universal terrestrial radio access, |
| | i.e., the LTE radio access technology |
| E-UTRAN | E-UTRA network |
| F1 | interface between the CU and the DU |
| FPGA | field-programmable gate array |
| gNB | base station for 5G/NR, i.e., |
| | a node providing NR user plane and |
| | control plane protocol terminations towards the UE, |
| | and connected via the NG interface to the 5GC |
| GNSS | global navigation satellite system |
| GSO | geostationary orbit (or geosynchronous orbit) |
| HAPS | high-altitude platform system |
| IAB | integrated access and backhaul |
| I/F | interface |
| I/O | input/output |
| IoT | internet of things |
| LEO | low earth orbit |
| LMF | location management function |
| LoS | line of sight |
| LTE | long term evolution (4G) |
| MAC | medium access control |
| MIMO | multiple input multiple output (e.g. in terms of antennas) |
| MME | mobility management entity |
| MRO | mobility robustness optimization |
| MUSIC | multiple signal classification |
| NCE | network control element |
| ng or NG | new generation |
| ng-eNB | new generation eNB |
| NGSO | non-geostationary orbit (or non-geosynchronous orbit) |
| NG-RAN | new generation radio access network |
| NR | new radio (5G) |
| NTN | non-terrestrial network |
| N/W | network |
| PDA | personal digital assistant |
| PDCP | packet data convergence protocol |
| PHY | physical layer |
| PLMN | public land mobile network |
| PUCCH | physical uplink control channel |
| PUSCH | physical uplink shared channel |
| RAM | random access memory |
| RAN | radio access network |
| RAN# | RAN study or meeting |
| RAN1 | radio layer 1 |
| RAN2 | radio layer 2 |
| RAN3 | radio layer 3 |
| RAT | radio access technology |
| Rel- | release |
| RLC | radio link control |
| ROM | read-only memory |
| RRC | radio resource control (protocol) |
| RU | radio unit |
| Rx | receiver or reception |
| SGW | serving gateway |
| SMF | session management function |
| SON | self-organizing/optimizing network |
| TN | terrestrial network |
| TRP | transmission reception point |
| Tx | transmitter or transmission |
| UAS | unmanned aerial system |
| UAV | unmanned aerial vehicle |
| UE | user equipment (e.g., a wireless, typically mobile device) |
| UL | uplink |
| UPF | user plane function |
| WID | work item description |
| X2 | network interface between RAN nodes and between RAN and |
| | core network |
| Xn | network interface between NG-RAN nodes |

1. An apparatus comprising:
at least one processor; and
at least one memory storing instructions that, when executed by the at least one processor, cause the apparatus at least to:
receive, from a network, a configuration to transition to a secondary mode of transmission;
wherein the transition to the secondary mode comprises modifying at least one network time compensation setting or at least one network frequency compensation setting; and
transmit, to the network, a signal in the secondary mode of transmission.

2. The apparatus of claim 1, wherein the transmitted signal is configured to be used with the network to verify a position of a terminal device.

3. The apparatus of claim 1, wherein the apparatus is caused to:
report to the network a timing advance used with a terminal device, the timing advance configured to be used with the network to verify a position of the terminal device with comparison of the timing advance to at least one characteristic of a channel used for transmission of the signal in a primary mode.

4. The apparatus of claim 1, wherein the apparatus is caused to:
report a position of a terminal device to the network for verification of the position of the terminal device.

5. The apparatus of claim 1, wherein the at least one network time compensation setting comprises a setting for a non-terrestrial network, and the at least one network frequency compensation setting comprises a setting for a non-terrestrial network.

6. The apparatus of claim 1, wherein the apparatus is caused to perform at least one of:
disable a terminal device specific time delay compensation or a common time delay compensation; or
disable Doppler shift compensation on a service link to a network or a feeder link to a gateway.

7. The apparatus of claim 1, wherein the secondary mode comprises the network having knowledge of at least one known characteristic of the signal.

8. The apparatus of claim 7, wherein the at least one known characteristic of the signal comprises transmission of the signal with at least one of:
a preamble sequence;
a physical channel;
a physical uplink control channel;
a physical uplink shared channel;
a pre-defined physical resource in a time domain;
a pre-defined physical resource in a frequency domain;
a pre-defined physical resource in a code domain; or
a pre-defined physical resource in a power domain.

9. The apparatus of claim 1, wherein the apparatus is caused to perform at least one of:
disable both time compensation and frequency compensation to simulate connection to a terrestrial network;
disable time compensation and apply at least one network timing command while compensating for frequency shift; or
disable frequency compensation while compensating for time shift.

10. The apparatus of claim 1, wherein the apparatus is caused to:
receive, from the network, a fixed point known to the network; and
adjust time delay compensation or Doppler frequency compensation based on the fixed point known to the network.

11. The apparatus of claim 1, wherein the apparatus is caused to:
receive, from the network, at least one value to use for the modifying of the at least one network time compensation setting or the at least one network frequency compensation setting; and
compensate using the at least one value received from the network.

12. The apparatus of claim 1, wherein the at least one network time compensation setting and the at least one network frequency compensation setting configure the terminal device to compensate for at least one channel impact occurring due to satellite movement.

13. An apparatus comprising:
at least one processor; and
at least one memory storing instructions that, when executed by the at least one processor, cause the apparatus at least to:
transmit, to a terminal device, a configuration used with the terminal device to transition to a secondary mode of transmission;
wherein the transition to the secondary mode comprises modification of at least one network time compensation setting or at least one network frequency compensation setting; and
receive a signal from the terminal device in the secondary mode of transmission.

14. The apparatus of claim 13, wherein the apparatus is caused to:
verify a position of the terminal device, based on the signal received in the secondary mode of transmission.

15. The apparatus of claim 13, wherein the apparatus is caused to:
receive a timing advance used with the terminal device; and
verify a position of the terminal device with comparing the timing advance to at least one characteristic of the channel used for transmission of the signal in a primary mode.

16. The apparatus of claim 13, wherein the apparatus is caused to:
receive, with a network from a terminal device, a reported position of the terminal device; and
verify the reported position of the terminal device, based on the signal received in the secondary mode of transmission;
wherein verifying the reported position of the terminal device comprises comparing at least one physical characteristic of the received signal to at least one expected characteristic of the received signal.

17. (canceled)

18. The apparatus of claim 13, wherein the apparatus is caused to perform at least one of:
configure the terminal device to disable a terminal device specific time delay compensation or a common time delay compensation; or
configure the terminal device to disable Doppler shift compensation on a service link to the network or a feeder link to a gateway.

19-21. (canceled)

22. The apparatus of claim 13, wherein the apparatus is caused to:
transmit, to the terminal device, a fixed point known to the network; and
configure the terminal device to adjust time delay compensation or Doppler frequency compensation based on the fixed point known to the network.

23. The apparatus of claim 13, wherein the apparatus is caused to:
transmit, to the terminal device, at least one value to use for the modification of the at least one non-terrestrial network time compensation setting or the at least one non-terrestrial network frequency compensation setting; and
configure the terminal device to compensate with use of the at least one value transmitted to the terminal device.

24. (canceled)

25. The apparatus of claim 13, wherein the apparatus is caused to:
determine a possible position of the terminal device given the signal received in the secondary mode, based on a timing of the signal or a frequency of the signal; and
determine a difference between the possible position of the terminal device given the signal received in the secondary mode, and the reported position of the terminal device; and
verify the reported position of the terminal device with determining whether the difference is within a value, wherein the value comprises a radius or other value.
